(19) United States
(12) Patent Application Publication
(10) Pub. No.: US 2010/0017339 A1
(43) Pub. Date: Jan. 21, 2010

(54) System and methods for ETF 401(k) trading

(75) Inventors: Win Cody, Cranbury, NJ (US); Mark Klein, Villanova, PA (US); James Marx, Ossining, NJ (US)

Correspondence Address: DILWORTH PAXSON LLP, 1500 Market Street, Suite 3500 E, PHILADELPHIA, PA, 19102, US

(73) Assignee: Professional Capital Services, LLC, Philadelphia, PA (US)

(21) Appl. No.: 12/322,826

(22) Filed: Feb. 5, 2009

Related U.S. Application Data
(60) Provisional application No. 61/063,796, filed on Feb. 5, 2008.

(51) Int. Cl. G06Q 40/00

(52) U.S. Cl. 705/36 R

(57) ABSTRACT

Systems and methods for providing an ETF 401(k) retirement plan administration are described. The typical requirement of purchasing full shares is addressed by establishing a breakage account. This account absorbs any extra money that would have bought a fraction of a share, purchases shares for the pool, and allows for an allotment of fractional shares that would not be possible otherwise.

### CROSS-REFERENCE TO RELATED APPLICATION

This United States non-provisional application claims the benefit of U.S. provisional patent application No. 61/063,796 filed Feb. 5, 2008, the entirety of which is incorporated by reference in this application.

### FIELD OF INVENTION

This invention is directed to systems and methods for managing investments, particularly an Exchange Traded Fund (ETF) 401(k) retirement plan.

### BACKGROUND OF THE INVENTION

Exchange Traded Funds (ETFs) are a stock-like security that is tied to a specific stock index, such as the Dow Jones Industrial Average or the S&P 500, allowing investors to buy and sell the entire index in a single transaction. This allows for greater diversification of an investment portfolio while limiting transaction costs. Recently, ETFs have been used as investment vehicles for employees' 401(k) retirement plans. But a major problem of previous ETF 401(k) systems is that, while ETFs must be purchased and sold in whole shares, participants in a 401(k) plan contribute varying amounts of dollars that will rarely, if ever, translate into exact whole shares.

One known method that seeks to address this problem is to keep a participant's contributions in cash until they have enough money to buy whole shares. This method is popular among employee stock-purchase plans, where participants buy shares when they have accumulated enough cash in their accounts to pay for whole shares. But for a 401(k) retirement plan built entirely, or nearly entirely, with ETFs, this approach is infeasible. Given a typical model having five ETF stocks in varying percentages, ETF 401(k) participants, especially those with low compensation or contribution levels, could have their contributions out of the market for many months before they accumulated enough money to buy a single ETF share, much less all the ETF shares in the correct proportions necessary to meet the investment objective of the model. For ETF 401(k) plans to work, trades need to be rounded to whole numbers.

If trades for ETF 401(k)s must be rounded to whole numbers, systems and methods for executing participant transactions in their entirety by rounding trades to whole shares are required.

### SUMMARY OF THE INVENTION

The present system aims to provide systems and methods for facilitating the rounding process in purchasing ETFs by providing a breakage account to contain any extra fractions of share prices. In one embodiment, a system according to the invention keeps track of the day's ETF and mutual-fund trades, then uses the ETF pricing to calculate how many additional shares could theoretically be purchased with the overrun in the breakage account. The system also contains a health-check loop, where the breakage account must be above a set level of funding to conduct any trades.

The system can be run under the auspices of a trustee to attribute earnings and provide accounting oversight, but based on the particular needs of the implementation, the account plan can be administered with minimal oversight. The presence of the trustee will change the location of the account and the particular formula used to allocate the ETF trades.

### BRIEF DESCRIPTION OF THE DRAWINGS

FIG. 1 is a flowchart of one process of one embodiment of a system according to the invention.

FIG. 2 is a flowchart of another process of one embodiment of a system according to the invention.

### DETAILED DESCRIPTION OF PREFERRED EMBODIMENTS

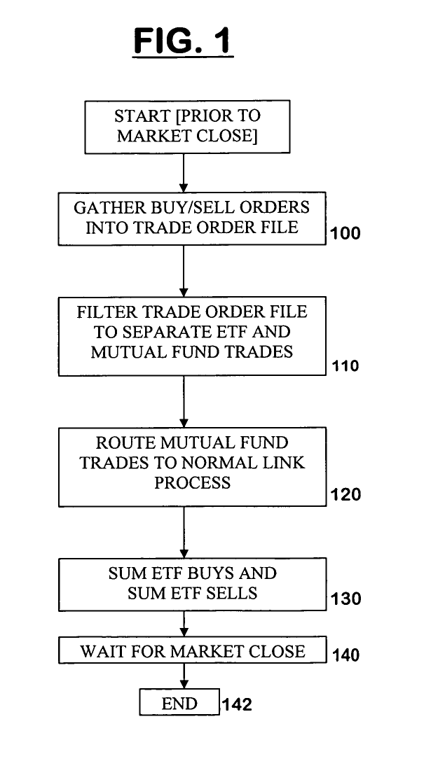

FIG. 1 illustrates the basic flow of one process in one embodiment of a system according to the invention. Two hours before the close of the market, the system will gather (at block 100) the buy/sell orders for both dollars and shares from the administrator's recordkeeping system into a standard trade order file. This file is then filtered (block 110) to separate the ETF trades from the mutual fund trades, and the mutual fund trades are routed 120 to the normal trading link processes. The ETF buys are summed 130 together per fund but across plans, as are the ETF sells. These sums are then passed to the trading agent as a raw indicator of the total share-certain sells and dollar-certain buys. These fund subtotals allow the ETF trading agent to ensure they will have the correct number of ETF shares available at the end of the day to fulfill the final net, rounded trade offers. The ETF trading agent then waits 140 for the market to close, and this process ends as indicated at block 142.

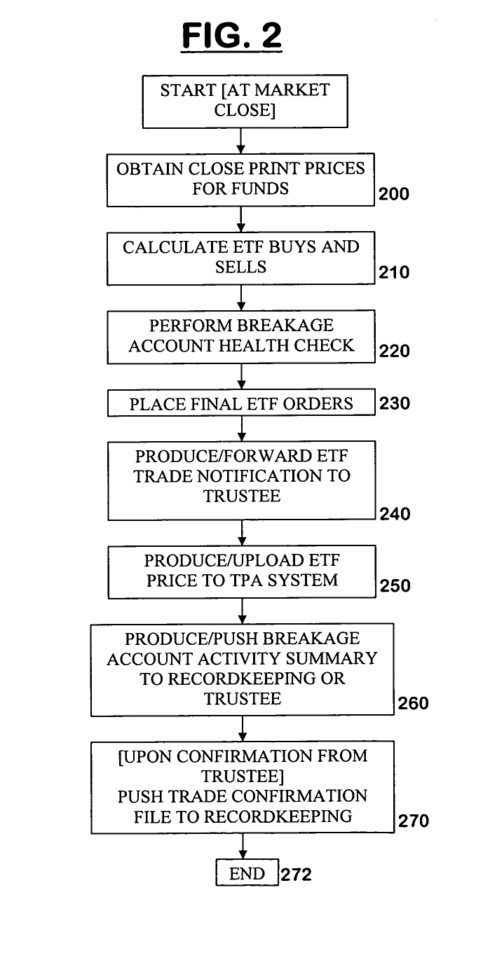

FIG. 2 illustrates another process of the system in this embodiment. Upon the market's close, the system will obtain 200 close print prices for the funds. The trades with the trade agent are guaranteed to be fulfilled at these prices and have been anticipated using the raw indication sent earlier in the day. The system then uses the prices to calculate 210 the ETF buys and sells using Basic Trade Order Calculations, as described below. The next step determines whether the Breakage account has enough capital for operation by checking 220 using the Basic Breakage Account Health Check, also described below. If the account is healthy, before 5:00 PM the system will place 230 a final ETF order based on closing prices and receive confirmation from the trading agent that the orders have been filled.

The next step is to produce and forward 240 the ETF Trade Notification of the day's ETF trades to the trustee for verification on the DTC. The Trade Notification includes original trades, net fund subtotals by plan and final cross plan net trade orders. Fund/dollar exchanges are carried out directly between the trustee and the trading agent across the DTC based on this Notification. The system will then produce and upload 250 the ETF price file to the recordkeeping system of the Third Party Administrator (TPA). This allows proper valuation of participant account values typically (number of shares held multiplied by current price) in the recordkeeping system and associated systems like the participant website.

The next step is determined by the Breakage Account Location, further determined by the desired level of involvement of the trustee. The system will produce and push 260 a Breakage Account Activity Summary to the recordkeeping system or the trustee, the Basic Trade Order Calculations for each potential process is outlined below. The Breakage Account Location is ultimately determined by whether or not a trustee feels comfortable maintaining plans with fractional shares of ETFs. Because ETFs can only be traded in whole units, some trustees may feel that they cannot attribute “pieces” of an ETF to a plan while others have no qualms. When a trustee is willing to allow plans to hold fractional units of an ETF, the helper account (the Breakage Account) needed to perform trading can be maintained at the Trustee level. When a trustee is unwilling to allow fractionals at the plan level, the Breakage Account must belong to the plan; hence a separate Breakage Account must be maintained for each plan that offers ETFs to its participants. Once the Breakage Account Activity Summary has reached the recordkeeping system, either pushed straight from the summary 260 or upon confirmation from the trustee 270, the recordkeeping system will remove trades from pending status and to send confirmation-dependant buys from ETF to mutual-fund exchanges. The process then ends, as shown at block 272.

A primary controlling issue, which may impact the basic calculations of how many ETF shares to buy or sell given the raw trade orders gathered from participants and plan transactions, is Breakage Account Location. A Breakage Account may be located with the Trustee, or a Breakage Account may be located at the plan level.

Scenario One: Breakage Account Located with the Trustee

This scenario requires an extra account to be held by the trustee that would be used to service the set of plans held by the TPA. This scenario allows plans to hold only what is owned by participants in the plan and keeps the extra fractional units that were needed to execute ETF trades in whole units to be held in the trustee's account along with enough cash to facilitate trading.

Under this scenario, the dollar amount of buys per fund, across plans, may be summed; this is referred to as Buy Dollars. Similarly, the dollar amount of share sells per fund, across plans, may also be summed; this is referred to as Sell Shares. Then, for each fund, the following may occur.

The Buy Dollars may be divided by the closing price to calculate the number of shares needed. The number of shares needed may be initially calculated as a non-integer. The number of shares needed may then be rounded. This may occur, for example, by rounding up to three decimal places, e.g., round up of 0.500 or higher, round down if below 0.500. The net transaction type and amount may then be calculated.

The number of shares to buy or sell may then be calculated by subtracting the number of shares to sell from the number of shares needed (e.g., (shares needed)−(shares to sell)=net shares to buy/sell).

If, from this calculation, shares need to be purchased, the cash needed to purchase the ETFs in whole units may then be calculated. The net shares to be purchased is rounded up to the next whole unit, and subtracted from the previously calculated net shares to buy/sell—resulting in a fractional value. The resulting fractional value may then be multiplied by the closing price of the fund to calculate the fractional needed share worth. The fractional needed share worth may need to be available in the Breakage Account as cash in order to complete the trade. If the Breakage Account does not have the necessary funds available, the trader may be warned of insufficient funding. The net shares to be purchased may then be rounded up to determine the final number of shares to purchase, and the fractional needed share worth may be removed from the Breakage Account accordingly.

If, however, from the calculation to determine the number of shares to buy or sell, it is determined that shares need to be sold, the sale may be rounded up, or the fractional portion may be cashed out by returning the fractional value to the Breakage Account. The net shares to sell may be rounded up to the next whole unit, and the rounded value may be subtracted from the original net shares to sell value, to determine the fractional needed. If the Breakage Account has more than, or the same as, the fractional needed shares of a fund, then the fractional needed shares may be sold from the Breakage Account, and the net shares to sell may be rounded up to determine the final shares to sell. If the Breakage Account does not have more than, or the same as, the fractional needed shares of a fund, then the fractional share unit (fractional to redeem) that must be purchased by the Breakage Account may be calculated by rounding net shares to sell down to the next whole unit and subtracting this value from the original net shares to sell value. Fractional to redeem share worth may be multiplied by the closing price to determine the value of the fractional to redeem. If the Breakage Account does not have funds equivalent to, or greater than, the fractional to redeem share worth, the trader may be warned of insufficient funding. If the Breakage Account has enough cash available to purchase the fractional to redeem, the fractional to redeem share worth may be subtracted from the Breakage Account, and the net shares to sell may be rounded down to calculate the final shares to sell.

After selling shares, SEC fees may be calculated. SEC fees on sells are standardized, at the time of authoring this document, at ((sell price)*(quantity sold)/1,000,000)*15.3). The Breakage Account may be evaluated to determine whether it contains sufficient funds for paying the SEC fees. If the Breakage Account does not have enough cash, the trader may be warned. If the Breakage Account has sufficient cash to pay the SEC fees, then the SEC fees may be subtracted from the Breakage Account.

The order for the final number of shares to buy or the final number shares to sell may be submitted, and adjustments in the Breakage Account cash and shares may then be recorded.

During settlement of a buy transaction, the trust may combine fractional share worth dollars from the Breakage Account with net shares to buy dollars from plans, in order to pay for trades. During settlement of a buy transaction, the trust may also allocate fractional needed shares to the Breakage Account and remaining shares according to plan subtotals.

During settlement of a sell transaction, the trust may determine whether the Breakage Account liquidated shares to round up a trade, or surrendered cash to purchase a fractional share and round down.

If the Breakage Account liquidated shares to round up a trade, the trust may combine fractional needed shares with plan shares to be sold and allocate proceeds for the fractional needed shares to the Breakage Account. If the Breakage Account surrendered cash to purchase a fractional share, the trust may (1) combine Breakage Account money with proceeds from sales to assign to plans according to plan subtotals; (2) assign fractional to redeem shares bought with the fractional to redeem share worth to the Breakage Account. In either case of a sell transaction the system removes SEC reimbursement money from the Breakage Account and add to proceeds of the sale for distribution to the plans, to ensure that the plans get the full, expected proceeds of the sale.

Scenario Two: Breakage Account Located with the Plan

Under this configuration, a Breakage Account is used within each plan, rather than across plans.

Under this scenario, the Buy Dollars may be calculated as a summation of the dollar buys per fund, per plan. The Sell Shares may be calculated as a summation of the share sells per fund, per plan. Then, for each fund in each plan, the following may occur.

The Buy Dollars may be divided by the closing price to calculate the number of shares needed. The number of shares needed may be initially calculated as a non-integer. The number of shares needed may then be rounded. This may occur, for example by rounding up to three decimal places, e.g., round up of 0.500 or higher, round down if below 0.500. The net transaction type and amount may then be calculated.

The number of shares to buy or sell may then be calculated by subtracting the number of shares to sell from the number of shares needed (e.g., (shares needed)−(shares to sell)=net shares to buy/sell).

If, from this calculation, shares need to be purchased, the cash needed to purchase the ETFs in whole units may then be calculated. The net shares to be purchased is rounded up to the next whole unit, and subtracted from the previously calculated net shares to buy/sell—resulting in a fractional value. The resulting fractional value may then be multiplied by the closing price of the fund to calculate the fractional needed share worth. The fractional needed share worth may need to be available in the plan's Breakage Account as cash in order to complete the trade. If the plan's Breakage Account does not have the necessary funds available, the trader may be warned of insufficient funding. The net shares to be purchased may then be rounded up to determine the final number of shares to purchase, and the fractional needed share worth may be removed from the Breakage Account accordingly. The fractional needed share may be assigned to the plan's Breakage Account.

If, however, from the calculation to determine the number of shares to buy or sell, it is determined that shares need to be sold, the sale may be rounded up, or the fractional portion may be cashed out by returning the fractional value to the plan's Breakage Account. The net shares to sell may be rounded up to the next whole unit, and the rounded value may be subtracted from the original net shares to sell value, to determine the fractional needed. If the plan's Breakage Account has more than, or the same as, the fractional needed shares of a fund, then the fractional needed shares may be sold from the plan's Breakage Account, and the net shares to sell may be rounded up to determine the final shares to sell. If the Breakage Account does not have more than, or the same as, the fractional needed shares of a fund, then the fractional share unit (fractional to redeem) that must be purchased by the plan's Breakage Account may be calculated by rounding net shares to sell down to the next whole unit and subtracting this value from the original net shares to sell value.

Fractional to redeem share worth may be multiplied by the closing price to determine the value of the fractional to redeem. If the plan's Breakage Account does not have funds equivalent to, or greater than, the fractional to redeem share worth, the trader may be warned of insufficient funding. If the plan's Breakage Account has enough cash available to purchase the fractional to redeem, (1) the fractional to redeem share worth may be subtracted from the plan's Breakage Account; (2) ownership of the liquidated fractional to redeem shares may be transferred to the plan's Breakage Account; and (3) the net shares to sell may be rounded down to calculate the final shares to sell.

After selling shares, SEC fees may be calculated. SEC fees on sells are standardized, at the time of authoring this document, at ((sell price)*(quantity sold)/1,000,000)*15.3). The Breakage Account may be evaluated to determine whether it contains sufficient funds for paying the SEC fees. If the Breakage Account does not have enough cash, the trader may be warned. If the Breakage Account has sufficient cash to pay the SEC fees, then the SEC fees may be subtracted from the Breakage Account.

The order for the final number of shares to buy or the final number shares to sell may be submitted, and adjustments in the plan Breakage Account cash and shares may then be recorded.

With all plan assets held at the plan level, transfers between the plan's Breakage Account and its participants may be accomplished entirely within a recordkeeping system. Unlike when the Breakage Account is located with the Trustee, no special settlement is required after the final shares to buy and sell are ordered, and adjustments of plan's Breakage Account cash and shares recorded.

### Checking Breakage Account Health

A sufficient level of funding must be maintained in the Breakage Account to facilitate ETF 401(k) trading. The Breakage Account holds market positions, and may be used to absorb SEC fees, and, consequently, may gradually lose money over time. The “health” of Breakage Account may be checked regularly, such as, for example, daily, to ensure adequate funding for any trading action. Such a check may include the following steps.

First, current prices may be gathered for every ETF fund that the Breakage Account operates to facilitate. Then, a minimum cash level—the absolute lowest dollar amount determined needed to carry out a time period's trading—is calculated. This may be calculated by adding together the prices for one full share of each ETF, and multiplying by a cushion factor. A cushion factor may be necessary to accommodate any rise in the value of an ETF between the time at which the check is performed, and the time of the next trade. A sufficient cushion factor may be, for example, 115%. With such a cushion factor, the minimum cash level may be calculated as ((sum of prices for all ETFs)*1.15).

Next, the current cash level of the Breakage Account is evaluated. In evaluating the cash level of the Breakage Account, only the available cash may be considered, without evaluating the value of any fractional shares currently held.

Then, the Breakage Account cash level may be compared to the minimum cash level as previously determined. The Breakage Account cash level may be compared to the minimum cash level using a multiplication factor to determine the relative health of the Breakage Account. Simply having a Breakage Account cash level greater than the minimum cash level provides little useful insight into the health of the Breakage Account. For example, the Breakage Account cash level is practically certain to be insufficient when only $1.00 greater than the minimum cash level; but may be just as insufficient even when $1,000 greater than the minimum cash level, because of dramatically increased ETF prices. Consequently, a percent calculation or other multiplication factor may be used to determine the final health status of the Breakage Account cash level.

This multiplication factor may be established by the trustee, trader, or another individual. The factor may be a value such as, for example, 1.5, or 150%. The minimum cash value may be multiplied by this factor and compared to the current cash level of the Breakage Account. If the minimum cash value multiplied by the factor (e.g., minimum cash value*1.5) is less than the current cash level of the Breakage Account, then the Breakage Account may be deemed sufficient for all upcoming buys and sells. If the minimum cash value multiplied by the factor is greater than the current cash level of the Breakage Account, but the current cash level is still greater than the minimum cash level, then the Breakage Account may not contain sufficient funds for all upcoming buys and sells. If the minimum cash level is greater than the current cash level of the Breakage Account, then the Breakage Account may not contain sufficient funds for all upcoming buys and sells.

The cushion factor of the Breakage Account Health Check and the minimum cash value multiplication factor may be adjusted over time. These factors may be adjusted in response to, for example, 401(k) trading data, greater market trends, or share prices.

It is to be understood that the figures and descriptions of the present invention have been simplified to illustrate elements that are relevant for a clear understanding of the present invention, while eliminating, for the purposes of clarity, many other elements that may be found in the present invention. Those of ordinary skill in the pertinent art will recognize that other elements are desirable or required in order to implement the present invention. Because such elements are well known in the art, and because such elements do not facilitate a better understanding of the present invention, a discussion of such elements is not provided in this description.

What is claimed is:

1. A computer-based system for managing an investment plan including Exchange Traded Funds (ETFs), comprising:
(a) a processor;
(b) means for storing data on a storage medium;
(c) means for processing data regarding gathering one or more buy/sell orders into a trade order file;
(d) means for processing data in the trade order file to identify share-certain ETF sells and dollar-certain ETF buys;
(e) means for processing data regarding closing mutual-fund prices;
(f) means for processing data regarding fractional ETF buys and ETF sells in a breakage account file; and
(g) means for processing data in the breakage account file to round each of one or more trades to a whole number.

2. A computer-based method for managing an investment plan including Exchange Traded Funds (ETFs), comprising:
(a) gathering one or more buy/sell orders into a trade order file;
(b) identifying in the trade order file share-certain ETF sells and dollar-certain ETF buys;
(c) obtaining closing mutual-fund prices;
(d) calculating fractional ETF buys and ETF sells and storing the results in a breakage account file; and
(e) rounding each of one or more trades to a whole number.

3. A medium storing instructions adapted to be executed by a computer processor to perform a method for managing an investment plan including Exchange Traded Funds (ETFs), the method comprising:
(a) gathering one or more buy/sell orders into a trade order file;
(b) identifying in the trade order file share-certain ETF sells and dollar-certain ETF buys;
(c) obtaining closing mutual-fund prices;
(d) calculating fractional ETF buys and ETF sells and storing the results in a breakage account file; and
(e) rounding each of one or more trades to a whole number.
